(19) United States
(12) Patent Application Publication
(10) Pub. No.: US 2025/0010249 A1
(43) Pub. Date: Jan. 9, 2025

(54) Surface Modification for Superphobic Membranes

(71) Applicant: EMD Millipore Corporation, Burlington, MA (US)

(72) Inventors: Joby Eldo, Andover, MA (US); Nitin Satav, Westford, MA (US)

(21) Appl. No.: 18/687,419

(22) PCT Filed: Nov. 7, 2022
(86) PCT No.: PCT/US2022/079379

§ 371 Date: Feb. 28, 2024

Related U.S. Application Data
(60) Provisional application No. 63/285,322, filed on Dec. 2, 2021.

(51) Int. Cl. B01D 71/68; B01D 71/34

(52) U.S. Cl. CPC B01D 71/68; B01D 71/34; B01D 2323/04; B01D 2323/30; B01D 2325/0283; B01D 2325/38

(57) ABSTRACT

A porous polymeric membrane which comprises a porous membrane having an average pore size between about 0.001 and 10.0 microns formed of a first polymer, said substrate having a surface which is modified on its surface with a cross-linked second polymer formed from a polymerizable fluorine containing monomer that contains continuous chain of 5 carbon atoms or less with fluorine atoms, said monomer being polymerized and crosslinked on said membrane, said membrane contains less than 25 ppb of C6 PFCA (Perfluorocarboxylic acid), less than 25 ppb of C8 PFCA and less than 25 ppb of combined C9-14 PFCA.

The application claims the benefit of priority to U.S. Provisional 63/285,322, dated Dec. 2, 2021, which is incorporated by reference in its entirety.

### FIELD

This application relates to membranes for use in the life science industry. In particular, embodiments of the technologies disclosed herein relate to hydrophobic membranes useful in filtration applications.

### BACKGROUND

This disclosure relates to membranes, for example, a porous membrane further comprising a hydrophobic surface. More particularly, this disclosure relates to a microporous or ultrafiltration membrane modified to produce a hydrophobic surface including the membrane pore surfaces and to a process for forming such a membrane.

Polytetrafluoroethylene (PTFE) has been commonly used material in membranes within devices used to vent gases. The chemical and biological inertness, thermal stability, and hydrophobicity inherently associated with PTFE has led to the development of PTFE as the material of choice in industrial gas vent applications. PTFE membranes have also found widespread use in the health and related industries. The necessity of producing aseptic vent membranes for use in medical/biological devices has also naturally led to the selection of PTFE as the choice material in membrane applications. Traditionally, aseptic materials have been generated by chemical sterilization, notably by steam treatment, gamma irradiation, or treatment with ethylene oxide. The compatibility of PTFE with sterilizing chemicals and treatments, especially at elevated temperatures, is a known material property characteristic of PTFE. A problem with the use of PTFE as a vent membrane material under steam treatment is pore blockage due to condensation of oil, from the machinery used to generate the steam, or water or both. The resulting loss of air permeability of the clogged membrane effectively reduces the membrane's utility as a gas vent. This condensation problem has led to the search and development of more hydrophobic and oleophobic membrane materials as substitutes for PTFE. A more acute problem concerns the chemical sterilization of membrane materials for use under aseptic conditions. Chemical sterilization, particularly with ethylene oxide, very often generates additional issues such as toxicity and waste disposal that raises serious health, environmental and economic concerns. These concerns have led to the widespread use of ionizing radiation for sterilization of materials used in medical and biological devices. A major disadvantage of PTFE is its inherent instability towards ionizing irradiation. Ionizing irradiation of PTFE membranes results in the undesirable property of reduced mechanical strength. This loss of mechanical strength places severe restrictions in the use of PTFE membranes under moderate pressures.

Attempts to solve these drawbacks of irradiation have included the use of coatings disposed on membranes. Coating of materials allows the retention of the desirable bulk materials properties while only altering the surface and interfacial properties of the membrane substrate. Hydrophobic and oleophobic coatings have found use in the electronics industry as protective barriers for electronic components. However, coating membranes has not been a practical approach for modifying the surface properties of membranes since the tortuous morphologies associated with membranes rarely produce continuous and even coatings. Furthermore, since coatings are not permanently anchored (bonded) to the underlying substrate, very often the coated materials are susceptible to wear such as delamination. Also, organic coatings can produce extractables, which can harm biological products. Each of these failure modes presents a limited range of thermal and chemical compatibility. In addition, coatings adversely affect the permeability properties of porous substrates, e.g., flux.

It also has been proposed to utilize grafting techniques to modify the surface characteristics of a polymer substrate. Typical examples of grafting techniques are shown, for example, in U.S. Pat. Nos. 3,253,057; 4,151,225; 4,278,777 and 4,311,573. Grafting techniques to modify the surface properties of porous membranes present manufacturing issues, e.g., difficulties in modifying the entire surface of the membrane including the surfaces within the pores while avoiding pore blockage and while retaining membrane porosity.

It has been proposed in U.S. Pat. No. 4,954,256 to render the surface of a microporous polymeric membrane more hydrophobic by grafting a fluoropolymer to the membrane surface in order to chemically bond the fluoropolymer to the membrane surface. The fluoropolymer is formed from a monomer containing an ethylenically unsaturated group and a fluoroalkyl group. The grafting is effected by exposing the membrane, in a monomeric solution, to ionizing radiation. A typical source of ionizing radiation is a Cobalt 60 gamma radiation source. The fluoropolymer formed from the fluorine-containing ethylenically unsaturated monomer is permanently bonded to the microporous membrane substrate.

Other prior art attempts disclose a process for preparing hydrophobic/oleophobic membranes that do not comprise surface modifications. Rather, in situ processes which, by virtue of a phase separation, both the underlying substrate and hydrophobic surface of the membrane are formed simultaneously by a photopolymerization process. The resulting membrane is weak mechanically and needs to be supported/laminated for use as a vent membrane under relatively moderate pressures. In addition, the process gives rise to membranes with a relatively narrow range of properties since the membrane morphology and surface characteristics are formed simultaneously. Another prior art attempt discloses a process for preparing hydrophobic and oleophobic porous substrates, which entails impregnating a porous substrate with a solution of a fluorinated monomer in a carrier solvent, removal of the solvent by evaporation, and then polymerization of the remaining monomer. The process is a solid-state polymerization reaction.

Another attempt includes a porous membrane substrate having a cross-linked, polymerizable monomeric composition coated on the substrate, for example, as is disclosed in U.S. Pat. Nos. 4,618,533 and 5,286,382. The monomeric composition includes a polymerizable monomer and a cross-linking agent for the monomer. Conventional energy sources for initiating free radical polymerization can be used to form a cross-linked polymeric coating in situ on the porous membrane such as ultraviolet (UV) light or heat. By this process, a membrane having its surface modified by the cross-linked polymer is produced. No mention is made of forming a cross-linked modified surface from an ethylenically unsaturated monomer having a fluoroalkyl group in U.S. Pat. Nos. 4,618,533. However, an ethylenically unsaturated monomer having a fluoroalkyl group is disclosed in U.S. Pat. No. 5,286,382.

U.S. Pat. No. 5,037,457 discloses a means for enhancing the mechanical strength of gamma irradiated PTFE membranes by laminating the PTFE membrane to a porous polyester web. This approach resolves issues regarding the mechanical stability of gamma irradiated PTFE. The chemical compatibility of the laminated membrane is limited by the properties of the porous web support. Furthermore, laminates are prone to delamination, particularly laminates formed by the use of adhesives, which often are sensitive to gamma radiation.

Superphobic membranes can be manufactured by surface modifying cast hydrophobic PVDF (DURAPORE®) and hydrophobic PES (EXPRESS®) membranes, as marketed by EMD Millipore Corporation, Burlington, MA, USA. Several pore sizes of PVDF membranes, e.g., 0.1, 0.2, 0.45, 0.65, 1, 5 micron (um) and one pore size (0.2 um) of PES membrane with superphobic chemistry have been commercially available for several years. The superphobic modification is carried out by polymerizing and cross-linking molecules containing fluorocarbons on the membrane surface. Such membranes are frequently used in venting filtration applications.

At least one monomer used for rendering a surface of a membrane superphobic is called Perfluorooctyl ethyl acrylate (POEA). This chemical falls under a list of chemicals, generally called PFAS (perfluoro alkyl substances) and was banned by the ECHA [European Chemicals Agency] under the REACH program [Registration, Evaluation, Authorization and Restriction of Chemicals]. Attempts have been made to substitute POEA with PDA (1H, 1H-Perfluoro-n-decyl acrylate). However, PDA also came under regulation. And, regulatory bodies continue to focus on PFAS, putting stringent threshold limits on impurity levels for degradation products as well as potential degradation products associated with these PFAS, which is generally 25 parts per billion (PPB).

Perfluorocarboxylic acids (PFCA), whether linear or branched, have been investigated for use. However, C9-C14 PFCA chemicals are subject to regulation and shall not be manufactured, placed on the market as substances on their own; nor be used in the production of, or placed on the market in: (a) another substance, as a constituent, (b) a mixture, or (c) an article in a concentration equal to or above 25 parts per billion (PPB) for the sum of C9-C14 PFCAs and their salts or 260 PPB for the sum of C9-C14 PFCA related substances. Perfluorocarboxylic acids (linear and/or branched), their salts and PFCA-related substances: (a) Perfluorocarboxylic acids with the formula: CnF2n+1−C(═O)OH n=8, 9, 10, 11, 12 or 13 including their salts and any combinations thereof; (b) Any PFCA-related substance having a perfluoro group with the formula CnF2n+1 directly attached to another carbon atom, where n=8, 9, 10, 11, 12 or 13, including any combinations thereof; (c) Any PFCA-related substance having a perfluoro group with the formula CnF2n+1 that is not directly attached to another carbon atom, where n=9, 10, 11, 12, 13 or 14 as one of the structural elements, including any combinations thereof. The following substances are excluded from this designation: (a) CnF2n+1−X, where X=F, Cl or Br where n=9, 10, 11, 12, 13 or 14, including any combinations thereof; (b) CnF2n+1−C(═O)OX′, where n>13 and X′=any group, including salts.

Undecafluorohexanoic acid (PFHxA), its salts and related substances are also highly regulated. PFHxA shall not be manufactured, used or placed on the market as substances on their own. And shall not be used or placed on the market in: (a) another substance, as a constituent, (b) a mixture, (c) an article in a concentration equal to or above 25 PPB for the sum of PFHxA and its salts or 1000 PPB for the sum of PFHxA-related substances. (a) Any PFHxA-related substance (including its salts and polymers) having a linear or branched perfluoropentyl group with the formula C5F11-directly attached to another carbon atom; (b) Any PFHxA-related substance (including its salts and polymers) having a linear or branched perfluorohexyl group with the formula C6F13-. The following substances are excluded from this chemical formula: (a) C6F13-X, where X=F; (b) C6F13-C(═O)OH, C6F13-C(═O)O—X′ or C6F13-CF2-X′ (where X′=any group, including salts).

With the foregoing in view, monomer alternatives to POEA for surface treatments, which are not subject to regulation for porous membranes, represent an advance in the art. A porous membrane having a surface treatment which is as hydrophobic, and/or more hydrophobic, than presently available membranes, and is not subject to regulation represents an advance in the art. In addition, a membrane having a surface treatment which retains its mechanical strength after being exposed to sterilizing ionizing radiation and which, upon environmental and other degradation, does not break down into PFOA represents an advance in the art. A C5 monomer for use with a cross-linking agent, to make an environmentally-friendly surface treatment for a membrane represents an advance in the art.

### SUMMARY OF THE DISCLOSURE

Embodiments of the disclosure include porous polymeric membranes which comprise a porous membrane having an average pore size between about 0.001 and 10 microns formed of a first polymer, said substrate having a surface which is modified on its surface with a cross-linked second polymer formed from a polymerizable fluorine containing monomer that contains continuous chain of 5 carbon atoms (“C5”) or less with fluorine atoms, said monomer being polymerized and crosslinked on said membrane, said membrane contains less than 25 ppb of C6 PFCA (Perfluorocarboxylic acid), less than 25 ppb of C8 PFCA and less than 25 ppb of combined C9-14 PFCA, substantially as shown in and/or described in connection with at least one of the figures, as set forth more completely in the claims, are disclosed. Novel and inventive features of the present disclosure, as well as details of exemplary embodiments thereof, will be more fully understood from the following description and drawings. Novel approaches for both monomers and cross-linkers and avoided use of any PFAS molecule equal to or greater than C6 carbon chain length in order to meet regulatory requirements. Approximately fifteen monomers were sourced and screened in the lab using both PVDF and PES base membranes. Three performance characteristics were measured: 1) surface energy (a measure of hydrophobicity), 2) air flow and 3) water intrusion pressure. While several of the new monomers were able to decrease the surface energy below 25 mJ/m2, only one was able to achieve the target surface energy of less than 19 mJ/m2. That monomer, DDA19, is a dodecane acrylate comprising nineteen fluorine atoms. Surface chemistry targets and methods according to some embodiments of the disclosure include a series of fluorinated functional acrylates/allylic (called monomers) and bi-functional acrylates (called cross-linkers), which were studied using the surface modification chemistry as described herein.

In some embodiments, the PVDF or PES membrane comprises pore sizes of any suitable size for a variety of filtration applications as are known to those of skill in the art. In some embodiments, the membrane comprises pore sizes between 0.001-10.0 microns. In some embodiments, the membrane comprises pore sizes between 0.01-5.0 microns. In some embodiments, the membrane comprises pore sizes between 0.05-1 microns. In some embodiments, the membrane comprises pore sizes between 0.1-0.22 microns. In some embodiments, the membrane comprises pore sizes of approximately 0.2-0.45 microns. Also, in some embodiments, the substrate comprises a woven or non-woven material. For example, suitable substrates comprise polyethylene, polypropylene, nylons, and other suitable polyolefins and/or polyamides.

These advances and others embodied herein will become clear from the description, claims, and figures below. Various benefits, aspects, novel and inventive features of the present disclosure, as well as details of exemplary embodiments of the coated membranes and venting filtration devices comprising the coated membranes thereof, will be more fully understood from the following description and drawings. Embodiments of the disclosure comprise a porous polymeric membrane that can be incorporated into a filter unit to facilitate venting of air or gas. So, the manner in which the features disclosed herein can be understood in detail, more particular descriptions of the embodiments of the disclosure, briefly summarized above, may be had by reference to the appended drawings. It is to be noted, however, that the appended drawings illustrate only typical embodiments of this disclosure and are therefore not to be considered limiting of its scope, for the described embodiments may admit to other equally effective surface treatments, methods, and/or materials. It is also to be understood that elements and features of one embodiment may be found in other embodiments without further recitation and that, where possible, identical reference numerals have been used to indicate comparable elements that are common to the figures. As used herein, the singular forms “a,” “an,” and “the” include plural referents unless the context clearly dictates otherwise. Unless defined otherwise, all technical and scientific terms used herein have the same meaning as commonly understood by one of ordinary skill in the art to which these embodiments pertain.

A surface is hydrophobic when its static water contact angle θ is >90° and is generally considered hydrophilic when 0 is <90°. Superphobic and superhydrophobic are defined herein as having a static water contact angle θ of approximately >150°.

Membrane surface modification or treatment is defined as a chemical process to get surface properties, e.g., hydrophobicity, while retaining the bulk membrane properties such as mechanical and chemical resistance, morphology, pore size

### BRIEF DESCRIPTION OF THE DRAWING

FIG. 1 depicts a flowchart for a method for making a coated membrane, according to some embodiments of the disclosure.

### DESCRIPTION OF SOME EMBODIMENTS

Embodiments of the disclosure include polyethersulfone (PES) and/or polyvinylidene fluoride (PVDF) membranes having surface modifications using various short-chain fluorocarbon acrylic or allylic based molecules. The PES and PVDF membranes having the surface treatments showed considerable increase in the superphobicity of the membrane surface. Embodiments of the membranes discussed herein are often used for various vent filter applications. The surface treatment step was achieved through the polymerization of acrylate molecules, followed by cross-linking with diacrylate molecules under an energy source of E-beam or ultraviolet (UV). The enhanced superphobic performance presented here is measured as surface energy. It is to be understood that in some embodiments, the PES or PVDF membrane(s) comprises pore sizes of any suitable size for a variety of filtration applications as are known to those of skill in the art. In some embodiments, the membrane comprises pore sizes between 0.001-10.0 microns. In some embodiments, the membrane comprises pore sizes between 0.01-5.0 microns. In some embodiments, the membrane comprises pore sizes between 0.05-1 microns. In some embodiments, the membrane comprises pore sizes between 0.1-0.22 microns. In some embodiments, the membrane comprises pore sizes of approximately 0.2-0.45 microns. Also, in some embodiments, the substrate comprises a woven or non-woven material. For example, suitable substrates comprise polyethylene, polypropylene, nylons, and other suitable polyolefins and/or polyamides, Any of these membranes and substrates may be treated with the surface treatments discussed herein to produce porous polymeric membranes for filtration applications.

Novel approaches for both monomers and cross-linkers and avoided use of any PFAS molecule equal to or greater than C6 carbon chain length in order to meet regulatory requirements. Approximately fifteen monomers were sourced and screened in the lab using both PVDF and PES base membranes. Three performance characteristics were measured: 1) surface energy (a measure of hydrophobicity), 2) air flow and 3) water intrusion pressure. While several of the new monomers were able to decrease the surface energy below 25 mJ/m2, only one was able to achieve the target energy of less than 19 mJ/m2. The monomer indicated, DDA19, is a dodecane acrylate comprising nineteen fluorine atoms.

Surface chemistry targets and methods according to some embodiments of the disclosure include a series of fluorinated functional acrylates/allylic (called monomers) and bi-functional acrylates (called cross-linkers), which were studied using the surface modification chemistry as described herein.

Table 3 discloses a summary of surface energy milliJoules per meter-squared (mJ/m²), a measure of the superphobicity of the membrane surface, of various chemistry solution/mix investigated as surface treatments on the various membranes.

Table 4 discloses the surface energy of current superphobic chemistry (POEA chemistry). Various chemistry formulations were identified from a series of studies performed at different formulation conditions. UV-source was used as an energy source to initiate the polymerization and cross-linking steps. It is contemplated herein that other sources, chemical sources and other energy sources, can be used to initiate polymerization and/or cross-linking processes.

TABLE 1
List of monomer molecules studied (15 molecules)

| | |
|---|---|
| 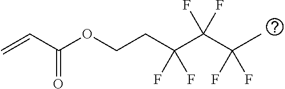 [SMILES: C=CC(=O)OCCC(F)(F)C(F)(F)C(C)(F)F] | 1 |
| PBEA | |
| 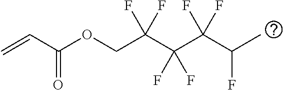 [SMILES: C=CC(=O)OCC(F)(F)C(F)(F)C(F)(F)C(C)F] | 2 |
| OFPA | |
| 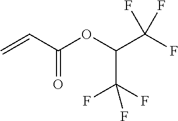 | 3 |
| HFIA | |
| 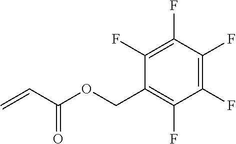 [SMILES: C=CC(=O)OCc1c(F)c(F)c(F)c(F)c1F] | 4 |
| PFBA | |
| 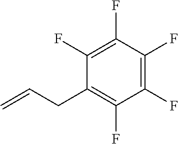 | 5 |
| APFB | |
| 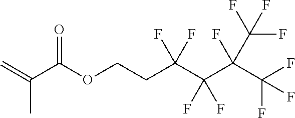 [SMILES: C=C(C)C(=O)OCCC(F)(F)C(F)(F)C(F)(C(F)(F)F)C(F)(F)F] | 6 |
| PHMA | |
| 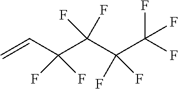 | 7 |
| PFHE | |
| 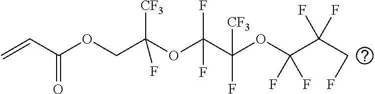 [SMILES: C=CC(=O)OCC(F)(OC(F)(F)C(F)(OC(F)(F)C(F)(F)CF)C(F)(F)F)C(F)(F)F] | 8 |
| PDNA | |
| 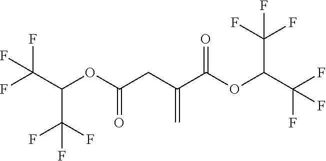 [SMILES: C=C(CC(=O)OC(C(F)(F)F)C(F)(F)F)C(=O)OC(C(F)(F)F)C(F)(F)F] | 9 |
| BHII | |
| 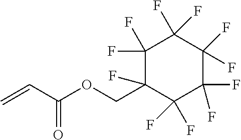 [SMILES: C=CC(=O)OCC1(F)C(F)(F)C(F)(F)C(F)(F)C(F)(F)C1(F)F] | 10 |
| PCHA | |
| 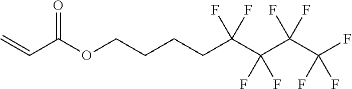 [SMILES: C=CC(=O)OCCCCC(F)(F)C(F)(F)C(F)(F)C(F)(F)F] | 11 |
| PFCA | |
| 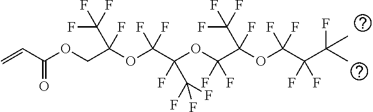 [SMILES: C=CC(=O)OCC(F)(OC(F)(F)C(F)(OC(F)(F)C(F)(OC(F)(F)C(F)(F)C(C)(C)F)C(F)(F)F)C(F)(F)F)C(F)(F)F] | 12 |
| PTDA | |
| 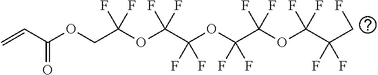 [SMILES: C=CC(=O)OCC(F)(F)OC(F)(F)C(F)(F)OC(F)(F)C(F)(F)OC(F)(F)C(F)(F)CF] | 13 |
| PTTA | |
| 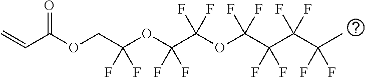 [SMILES: C=CC(=O)OCC(F)(F)OC(F)(F)C(F)(F)OC(F)(F)C(F)(F)C(F)(F)C(C)(F)F] | 14 |
| PDDA | |
| 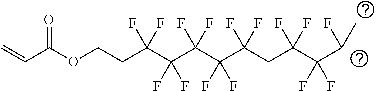 [SMILES: C=CC(=O)OCCC(F)(F)C(F)(F)C(F)(F)C(F)(F)C(F)(F)CC(F)(F)C(F)(F)C(C)F] | 15 |
| DDA19 | |

Types of fluorocarbon molecules selected
1. Short & linear chain (1-2 & 11)
2. Short & branched (3)
3. Aromatics (4-5)
4. Long & terminal branched (6)
5. Short & linear vinylic (7)
6. Short & branched chains with Oxygen spacer (8 & 12)
7. Short & linear chains with Oxygen spacer (13-14)
8. Short & linear chains with Carbon spacer (15)
9. Dimeric chain (9)
10. Non-aromatic cyclic (10)
Expansion of acronyms/chemical names
PBEA: 2-(Perfluorobutyl) ethyl acrylate
OFPA: 2,2,3,3,4,4,5,5-Octafluoropentyl acrylate
HFIA: Hexafluoroisopropyl acrylate
PFBA: Pentafluorobenzyl acrylate
PHMA: 3,3,4,4,5,6,6,6-Octafluoro-5-(Trifluoromethyl) Hexyl
Methacrylate
PFHE: Perfluoro-1-hexene
PDNA: [1H,1H-Perfluoro(2,5-dimethyl-3,6-dioxanonanoyl)] acrylate
BHII: Bis(1,1,1,3,3,3-hexafluoroisopropyl)itaconate
APFB: Allylpentafluorobenzene
PCHA: Perfluorocyclohexylmethylacrylate
PFCA: 1H,1H,2H,2H.3H,3H,4H,4H-perfluorooctyl acrylate
PTDA: 1H,1H-Perfluoro-2,5,8-trimethyl-3,6,9-trioxadodecan-1-ol
acrylate
PTTA: 1H,1H-Perfluoro-3,6,9-trioxatridecan-1-ol acrylate
PDDA: 1H,1H-perfluoro-3,6-dioxadecan-1-ol acrylate
DDA19: Dodecyl acrylate (2-Propenoic acid, 3,3,4,4,5,5,6,6,7,7,9,9,
10,10,11,11,12,12, 12-nonadecafluorododecyl ester)

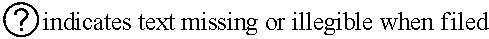

TABLE 2
List of cross-linker molecules studied (2 molecules)

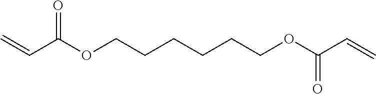 [SMILES: C=CC(=O)OCCCCCCOC(=O)C=C]

HDDA: 1,6-Hexanediol diacrylate

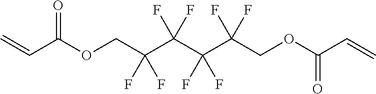 [SMILES: C=CC(=O)OCC(F)(F)C(F)(F)C(F)(F)C(F)(F)COC(=O)C=C]

PHDDA: Octafluorohexyl diacrylate

TABLE 3
List of surface energy of various chemistry solution/mix

| # | Monomer | Cross-linker | Surface Energy |
|---|---|---|---|
| 1 | PBEA | PHDDA | 24.8 |
| 2 | HFIA | PHDDA | 34.0 |
| 3 | PFBA | HDDA | 32 |
| 4 | APFB | HDDA | 41.0 |
| 5 | OFPA | PHDDA | 30.0 |
| 6 | PHMA | HDDA/PHDDA | 32-33 |
| 7 | PFHE | PHDDA | 33.2 |
| 8 | PDNA | PHDDA | 23.5 |
| 9 | BHII | PHDDA | 32.3 |
| 10 | PCHA | PHDDA | 26.0 |
| 11 | PFCA | PHDDA | 26.0 |
| 12 | PTDA | PHDDA | 22.4 |
| 13 | PTTA | HDDA-PHDDA | 22-23 |
| 14 | PDDA | HDDA-PHDDA | 23-24 |
| 15 | DDA19 | HDDA-PHDDA | 18.4 |

TABLE 4
Surface energy of POEA chemistry

| | | Surface Energy |
|---|---|---|
| Monomer | Cross-linker | (mJ/m²) |
| POEA | HDDA | 18.4 |

Table 5 discloses various chemistry used and membrane performance (surface energy, air flow and water intrusion pressure) comparison of current (POEA) and Novel DDA19 chemistries.

DDA19 is the name for a monomer of dodecane acrylate comprising 19 fluorine groups. The chemical structure of 2-Propenoic acid, 3,3,4,4,5,5,6,6,7,7,9,9,10,10,11,11,12,12,12-nonadecafluorododecyl ester (DDA19) can include:

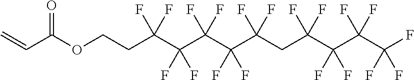 [SMILES: C=CC(=O)OCCC(F)(F)C(F)(F)C(F)(F)C(F)(F)C(F)(F)CC(F)(F)C(F)(F)C(F)(F)C(F)(F)F]

TABLE 5
Performance comparison of current (POEA) and novel DDA19 chemistries.

| | | | | | | | | Water |
|---|---|---|---|---|---|---|---|---|
| | Cross- | | | | | Surface | | Intrusion |
| Monomer | linker | | | | | Energy | Air-flow | Pressure |
| (%) | (%) | Initiator | Membrane | Solvent | Source | (mJ/m²) | (L/(min*psi)) | (PSI) |
| POEA | HDDA | DMPA | PVDF | DMTS | UV | 18.4 | 0.383 | 56.0 |
| (4.2) | (0.84) | | | | | | | |
| POEA | HDDA | DMPA | PES | DMTS | UV | 18.4 | 0.745 | 77.5 |
| (3.1) | (0.81) | | | | | | | |
| DDA19 | HDDA | DMPA | PVDF | DMTS | UV | 18.4 | 0.343 | 56.5 |
| (3.8) | (0.76) | | | | | | | |
| DDA19 | HDDA | DMPA | PES | DMTS | UV | 18.4 | 0.714 | 81.5 |
| (3.1) | (0.71) | | | | | | | |

TABLE 6
Membrane/Pore size

| | Ratio | | | | | |
|---|---|---|---|---|---|---|
| | (monomer/ HDDA) | Formulations | | | | |
| | | | Concentration (% wt.) | | | |
| | | | DDA19 | HDDA | DMPA | DMTS |
| | | Run No. | (%) | (%) | (%) | (%) |
| PES/0.2 | 5.00 | Max | 14.4 | 0.88 | 0.17 | 94.55 |
| microns or | | Nom | 3.8 | 0.76 | 0.17 | 95.27 |
| PVDF/0.2 | | Min | 3.2 | 0.64 | 0.17 | 95.99 |
| microns | | | | | | |
| | | | Concentration (% wt.) | | | |
| | | | DDA19 | HDDA | DMPA | DMTS |
| | | Run No. | (%) | (%) | (%) | (%) |
| PES/0.2 | 3.84 | Max | 4.4 | 1.15 | 0.15 | 94.3 |
| microns or | | Nom | 3.8 | 0.99 | 0.15 | 95.06 |
| PVDF/0.2 | | Min | 3.2 | 0.83 | 0.15 | 95.82 |
| microns | | | | | | |
| | | | Concentration (% wt.) | | | |
| | | | DDA19 | HDDA | DMPA | DMTS |
| | | Run No. | (%) | (%) | (%) | (%) |
| PES/0.2 | 4.32 | Max | 3.8 | 0.88 | 0.15 | 95.17 |
| microns or | | Nom | 3.2 | 0.74 | 0.15 | 95.91 |
| PVDF/0.2 | | Min | 2.6 | 0.60 | 0.15 | 96.65 |
| microns | | | | | | |
| | | | Concentration (% wt.) | | | |
| | | | DDA-19 | HDDA | DMPA | DMTS |
| | | Run No. | (%) | (%) | (%) | (%) |
| PES/0.2 | 4.84-4.94 | Max | 4.4 | 0.89 | 0.16 | 94.55 |
| microns or | | Nom | 3.8 | 0.77 | 0.16 | 95.27 |
| PVDF/0.2 | | Min | 3.2 | 0.66 | 0.16 | 95.98 |
| microns | | | | | | |
| | | | Concentration (% wt.) | | | |
| | | | PTTA | HDDA | DMPA | DMTS |
| | | Run No. | (%) | (%) | (%) | (%) |
| PES/0.2 | 5.00 | Max | 5 | 1 | 0.15 | 93.85 |
| microns or | | Nom | 4 | 0.8 | 0.15 | 95.05 |
| PVDF/0.2 | | Min | 3 | 0.6 | 0.15 | 96.25 |
| microns | | | | | | |
| | | | Concentration (% wt.) | | | |
| | | | DDA-19 | HDDA | DMPA | DMTS |
| | | Run No. | (%) | (%) | (%) | (%) |
| PES/0.2 | 3.82-4.33 | Max | 4.4 | 1.15 | 0.17 | 94.28 |
| microns or | | Nom | 3.5 | 0.77 | 0.16 | 95.46 |
| PVDF/0.2 | | Min | 2.6 | 0.60 | 0.15 | 96.65 |
| microns | | | | | | |

Table 7 depicts the pre- and post-gamma treatment of membranes having the novel coating applied thereto containing less than 25 ppb of C6 PFCA (Perfluorocarboxylic acid), less than 25 ppb of C8 PFCA and less than 25 ppb of combined C9-14 PFCA. The values shown in Table 7 (shown in nanograms per gram) will vary from lot-to-lot, although not substantially, e.g., less than 25 PPB.

TABLE 7

| | C6 | C8 (PFOA) | Total |
|---|---|---|---|
| | C₆HF₁₁O₂ | C₈HF₁₅O₂ | C9-C14 |
| Membrane Sample | ng/g | ng/g | PFCA ng/g |
| Pre-Gamma PVDF | <0.4 | <0.4 | 1.2 |
| Post-Gamma PVDF (n = 3) | <0.4 | <0.4 | 2.9 |
| Pre-Gamma PES | <0.7 | <0.7 | 1.4 |
| Post-Gamma PES (n = 3) | <0.7 | <0.7 | 3.1 |

The polymerization and cross-linking of the polymerizable monomer onto the porous membrane substrate is performed such that the surface of the porous membrane, including the inner surfaces of the porous membrane, is coated with a cross-linked polymer using a reagent bath.

A reagent bath comprised of: (1) a polymerizable monomer which is ethylenically unsaturated and has at least one fluoroalkyl group, (2) a polymerization initiator, if needed, and (3) a cross-linking agent in a solvent for these three reagents, is contacted with the porous membrane substrate under conditions to effect polymerization of the monomer and deposition of the resulting cross-linked polymer onto the porous membrane substrate.

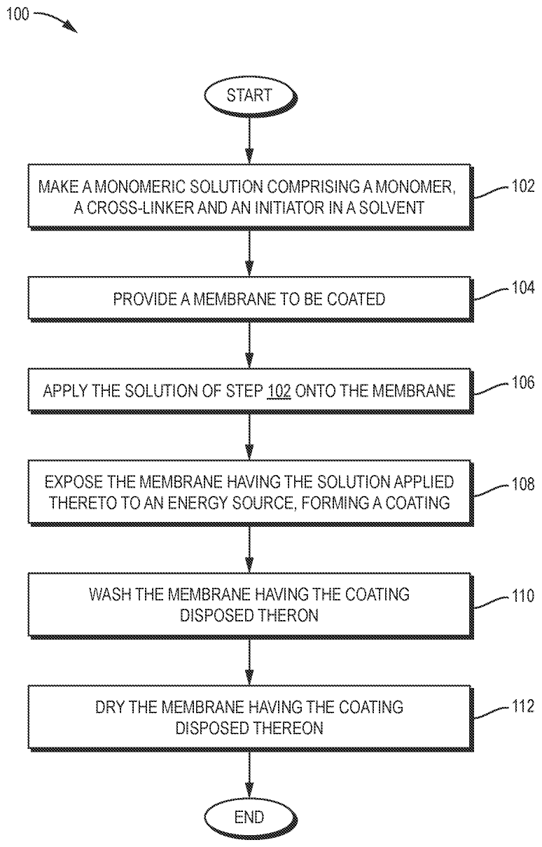

FIG. 1 depicts a flowchart for a method 100 for making a coated membrane, according to some embodiments of the disclosure. At step 102 of the method 100, a solution is made. For example, the polymeric solution comprises making the chemistry solution/mix with a monomer (e.g., DDA19) and a cross-linker (e.g., HDDA) with an initiator (e.g., DMPA/I651) in a DMTS solvent. 1651 is a photoinitiator marketed by Ciba Corp., NY, USA, as IRGACURE, having CAS #24650-42-8. Many initiators may be used in some embodiments within the disclosure.

At step 104, a membrane, which may be an asymmetric membrane or a symmetric membrane, is prepared. Also, the membrane may be a PES or a PVDF membrane. One way of preparing the membranes is to prepare a membrane sheet(s) for coating with the chemistry solution/mix from step 102. For example, cutting a desired size (e.g., 5″×3″) of base membranes for either PVDF and PES.

At step 106, the chemistry solution/mix is applied on a membrane surface. The application of the chemistry solution/mix can be done either by immersing the membrane sheet in the chemistry mix solution in a tray, e.g., a glass tray or by disposing the chemistry solution/mix directly on the membrane surface (in some embodiments, a wetted membrane surface) using, e.g., a pipette or other delivery means.

At step 108, the membrane sheets having the chemistry solution/mix is exposed to an energy source, e.g., UV/e-beam source for polymerization reaction, creating a polymeric coating on the membrane surface.

At step 110, a washing step is employed to remove unreacted chemistry solution/mix using solvents (e.g., methanol and water).

At step 112, a drying step is employed to dry the washed membrane (e.g., 100° C. for 15 minutes). The method 100 ends following step 112.

It has been found that by choosing the appropriate solvent system, the hydrophobicity of the membrane having the surface treatment can be controlled such that the coated membrane does not wet with solvents whose surface tension is greater than about 21 dynes/cm. Many such solvent systems are available. One such appropriate solvent for use with embodiments according to the disclosure is Decamethyltetrasiloxane (DMTS). Another monomer is 1H,1H-Perfluoro-3,6,9-trioxatridecan-1-ol acrylate (PTTA). The generic name for the initiator 1651 is 2,2-dimethoxy-2-phenylacetophenone (DMPA).

When utilizing fluorine containing polymerizable monomers having more than one degree of unsaturation, an additional monomer in the coating of this disclosure need not be added. The three reactants, e.g., a polymerizable monomer, polymerization initiator and cross-linking agents are contacted with the porous membrane as a mixture in a solvent which is compatible with the three reactants and the porous membrane so that the desired free radical polymerization and cross-linking is achieved without the formation of a significant amount of slowly extractable by-products. If readily extractable by-products are formed, these can be removed by conducting a washing step with a suitable solvent subsequent to the coating step.

Generally, the polymerizable monomer is present in the reactant solution at a concentration between approximately 2% and approximately 20%. In some embodiments, between approximately 2.5% and 7.5% based upon the weight of the polymerizable monomer. The cross-linking agent is present in an amount of between approximately 0.5% and approximately 5% by weight, based upon the weight of the polymerizable monomer. The polymerization initiator is present in an amount of between about 0.1% and about 1% by weight, based upon the weight of the polymerizable monomer. In some embodiments, the initiator is present in an amount of approximately 0.15-0.17%. The cross-linking agent can be utilized without the monomer and thereby functions as the polymerizable monomer.

Polymerization and cross-linking may be effected by exposing the monomer reaction system to ultraviolet (UV) light, thermal sources, and/or ionizing radiation. Embodiments of the disclosure comprise using UV light because it is quick. The process comprises dipping the membrane substrate in the solution containing the monomer, cross-linking agent, and the initiator, placing the membrane between two ultraviolet light transparent sheets such as polyethylene and exposing the sandwich to UV light. This process can be effected continuously and the desired cross-linking coating is formed within minutes after UV exposure is initiated. By controlling the reactant concentrations and UV exposure, as set forth above, a composite is produced which is unplugged and has the same porous configuration as the membrane substrate. Furthermore, the composite membrane produced is wettable only by solvents that have a surface tension of less than about 21 dynes/cm. That is, the composites and/or coated membranes of this disclosure have a highly hydrophobic surface. And, composites and/or coated membranes of this disclosure retain their mechanical strength even after being exposed to sterilizing ionizing radiation.

The composites of this disclosure, after being sterilized by exposure to gamma radiation, usually between about 2 and 5 MegaRads are capable of withstanding a forward or reverse pressure of at least 10 PSI. In addition, the sterilized membrane composite of this disclosure retains a desirable degree of hydrophobicity such that it is not wet by aqueous solutions including solutions containing surfactants. The composites are useful as gas vents to selectively pass gas through while preventing passage of organic and aqueous liquids through such as in the apparatus described in U.S. Pat. No. 3,854,907 which is incorporated herein by reference. Embodiments of the disclosure include membranes suitable for use in filtering devices. The membrane is a hydrophobic membrane incorporated into a filtering device that allows gas to be selectively vented, i.e., impervious to aqueous solutions, as, for example, when an aqueous solution is filtered through a hydrophilic filter prior to intravenous administration. As an integral part of the filtering device, the membrane remains hydrophobic, i.e., not wet by aqueous solutions, in its functional use(s) as a gas vent membrane and incorporation into a vent filter device.

It is contemplated herein that some embodiments of the disclosure include a porous polymeric membrane having a surface treatment disposed thereon that, upon exposure to gamma radiation of up to 50 kGy, contains less than 25 ppb of C6 PFCA (Perfluorocarboxylic acid), less than 25 ppb of C8 PFCA and less than 25 ppb of combined C9-14 PFCA.

The porous polymeric membrane according to some embodiments of the disclosure wherein comprise polyvinylidene fluoride, nylons, polyamides, polyimides, polyethersulfones, polysulfones, polyarylsulfones, cellulose, regenerated cellulose, cellulose esters, acrylic polymers methacrylic polymers, copolymers acrylic methacrylic polymers, and combinations thereof.

The water intrusion test approach is a “pressurized” wettability/adsorptivity test that allows one to indirectly assess the hydrophobicity of the interior surfaces of the porous membrane. This pressurized wettability/adsorptivity approach may be extended in its utility to solutions other than aqueous nutrient mixtures in order to assess membrane performance under a variety of working (e.g., venting) conditions.

All ranges for formulations recited herein include ranges therebetween and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4, or 3.1 or more.

Reference throughout this specification to “one embodiment,” “certain embodiments,” “one or more embodiments,” “some embodiments,” or “an embodiment” indicates that a feature, structure, material, or characteristic described in connection with the embodiment is included in at least one embodiment of the disclosure. Therefore, the appearances of the phrases such as “in one or more embodiments,” “in certain embodiments,” “in one embodiment,” “some embodiments,” or “in an embodiment” throughout this specification are not necessarily referring to the same embodiment.

Although some embodiments have been discussed above, other implementations and applications are also within the scope of the following claims. Although the specification describes, with reference to particular embodiments, it is to be understood that these embodiments are merely illustrative of the principles and applications of the present disclosure. It is therefore to be further understood that numerous modifications may be made to the illustrative embodiments and that other arrangements and patterns may be devised without departing from the spirit and scope of the embodiments according to the disclosure. Furthermore, particular features, structures, materials, or characteristics may be combined in any suitable manner in any one or more of the embodiments.

Publications of patent applications and patents and non-patent references cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

1. A porous polymeric membrane which comprises a porous membrane having an average pore size between:
0.001-10.0 microns, or
0.01-5.0 microns, or
between 0.05-1 microns, or
between 0.1-0.22 microns, or
between 0.2-0.45 microns, formed of a first polymer,
said porous polymeric membrane having a surface which is modified on its surface with a cross-linked second polymer formed from a polymerizable fluorine containing monomer that contains continuous chain of 5 carbon atoms or less with fluorine atoms, said monomer being polymerized and crosslinked on said membrane, said membrane contains less than 25 ppb of C6 PFCA (Perfluorocarboxylic acid), less than 25 ppb of C8 PFCA and less than 25 ppb of combined C9-14 PFCA.

2. The porous polymeric membrane of claim 1 contains less than 25 ppb of C6 PFCA (Perfluorocarboxylic acid), less than 25 ppb of C8 PFCA and less than 25 ppb of combined C9-14 PFCA after it is exposed to gamma radiation of up to 50 kGy.

3. The porous polymeric membrane of claim 1 wherein the first polymer comprising of polyvinylidene fluoride, nylons, polyamides, polyimides, polyethersulfones, polysulfones, polyarylsulfones, cellulose, regenerated cellulose, cellulose esters, acrylic polymers methacrylic polymers, copolymers acrylic methacrylic polymers, and combinations thereof.

4. The porous polymeric membrane of claim 1, wherein the membrane is an asymmetric membrane or a symmetric membrane.

5. The porous polymeric membrane of claim 1, wherein the membrane comprises a polyvinylidene fluoride membrane or a polyethersulfone membrane.

6. The porous polymeric membrane of claim 1, can be incorporated into a filter unit to facilitate venting of air or gas.

7. A porous polymeric membrane having a surface treatment, comprising:
a porous membrane having an average pore size between about 0.001 and 0.22 microns formed of a first polymer, said porous membrane having a surface which is modified on its surface with a cross-linked second polymer; wherein the cross-linked second polymer further comprises between 3.2% to 4.4% by weight fluorinated acrylate and 0.66 to 0.89 1,6 hexanediol diacrylate.

8. A porous polymeric membrane having a surface treatment, comprising:
a porous membrane having an average pore size between about 0.001 and 0.22 microns formed of a first polymer, said porous membrane having a surface which is modified on its surface with a cross-linked second polymer; wherein the cross-linked second polymer further comprises between 2.6% to 4.4% by weight fluorinated acrylate and 0.60 to 1.15 1,6 hexanediol diacrylate.

9. The porous polymeric membrane having a surface treatment of claim 7, wherein the cross-linked second polymer further comprises between 0.15-0.17% initiator.

10. The porous polymeric membrane having a surface treatment of claim 7, wherein the cross-linked second polymer further comprises 0.15-0.17% 2,2-dimethoxy-2-phenylacetophenone.

11. The porous polymeric membrane having a surface treatment of claim 7, wherein the first polymer comprising of polyvinylidene fluoride, nylons, polyamides, polyimides, polyethersulfones, polysulfones, polyarylsulfones, cellulose, regenerated cellulose, cellulose esters, acrylic polymers methacrylic polymers, copolymers acrylic methacrylic polymers, and combinations thereof.

12. The porous polymeric membrane having a surface treatment of claim 7, wherein the membrane is an asymmetric membrane or a symmetric membrane.

13. The porous polymeric membrane having a surface treatment of claim 7, wherein the membrane comprises a polyvinylidene fluoride membrane or a polyethersulfone membrane.

14. The porous polymeric membrane having a surface treatment of claim 7, can be incorporated into a filter unit to facilitate venting of air or gas.

15. The porous polymeric membrane having a surface treatment of claim 7, further comprising decamethyltetrasiloxane as a solvent.

16.-20. (canceled)
